(19) United States
(12) Patent Application Publication
(10) Pub. No.: US 2009/0014470 A1
(43) Pub. Date: Jan. 15, 2009

(54) Liquid dispensing device

(76) Inventor: Yung Hsing Lin, Taichung (TW)

Correspondence Address: CHARLES E. BAXLEY, ESQUIRE, 90 JOHN STREET, SUITE 309, NEW YORK, NY, 10038, US

(21) Appl. No.: 11/827,586

(22) Filed: Jul. 11, 2007

(51) Int. Cl. B65D 35/28; B65D 35/56; B67D 5/08; B67D 5/64

(52) U.S. Cl. 222/95; 222/105; 222/173; 222/2

(57) ABSTRACT

A liquid dispensing device includes a resilient receptacle for receiving a liquid and attached to a cover device and having a bellows-shape for providing a resilience to the resilient receptacle and for forcing the liquid out of the resilient receptacle and into the cover device by the resilience of the receptacle, and a controlling device for controlling the liquid to flow out of the cover device, the liquid may flow out of the receptacle by the resilience of the receptacle for allowing the liquid dispensing device to be erectly disposed on the table without being disposed up side down and without being mounted onto the supporting wall, and for allowing the receptacle to be changed with new ones.

### BACKGROUND OF THE INVENTION

1. Field of the Invention

The present invention relates to a liquid dispensing device, and more particularly to a liquid dispensing device including a resilient bladder for containing the liquid or viscous fluid and for forcing the liquid or viscous fluid out of the resilient bladder and for allowing the liquid dispensing device to be erectly disposed without being disposed up side down and for allowing the bladder to be changed or replaced with new ones.

2. Description of the Prior Art

Typical liquid dispensing devices comprise a casing disposed in an outer housing for containing the liquid or viscous fluid, in which the casing and the outer housing should be disposed up side down for allowing the liquid or viscous fluid to flow downwardly and to flow out of the casing, and a control valve or device disposed below the casing for controlling the liquid or viscous fluid to flow out of the casing.

For example, U.S. Pat. No. 4,667,854 to McDermott et al, and U.S. Pat. No. 4,741,461 to Williamson et al. disclose two of the typical liquid dispensing devices each also comprising a casing disposed up side down for allowing the liquid or viscous fluid received in the casing to flow downwardly and to flow out of the casing by the gravity force.

However, it is required to attach or to mount the casing and the outer housing onto the supporting wall, and it will be inconvenient for the users to mount the casing and the outer housing onto the supporting wall by themselves.

U.S. Pat. No. 4,961,508 to Weimer et al., and U.S. Pat. No. 5,082,150 to Steiner et al. disclose two further typical liquid dispensing devices each also comprising a casing for containing the liquid or viscous fluid, and the casing should also be mounted onto the supporting wall, and should also be disposed up side down for allowing the liquid or viscous fluid received in the casing to flow downwardly and to flow out of the casing by the gravity force.

However, similarly, it is also required to attach or to mount the casing onto the supporting wall, and it will be inconvenient for the users to mount the casing and the outer housing onto the supporting wall by themselves.

In addition, after the liquid or viscous fluid has been completely flown out of the casing or after the casing has been emptied, the casing and the outer housing are normally discarded, and the casing may not be changed or replaced with the other casings that are filled with liquid or viscous fluid.

The present invention has arisen to mitigate and/or obviate the afore-described disadvantages of the conventional liquid dispensing devices.

### SUMMARY OF THE INVENTION

The primary objective of the present invention is to provide a liquid dispensing device including a resilient bladder for containing the liquid or viscous fluid and for forcing the liquid or viscous fluid out of the resilient bladder and for allowing the liquid dispensing device to be erectly disposed on the table or the like without being disposed up side down.

The other objective of the present invention is to provide a liquid dispensing device including a resilient bladder for containing the liquid or viscous fluid and for allowing the bladder to be changed or replaced with new ones.

In accordance with one aspect of the invention, there is provided a liquid dispensing device comprising a cover device, a resilient receptacle for receiving a liquid and attached to the cover device, and including a bellows-shape for providing a resilience to the resilient receptacle and for forcing the liquid out of the resilient receptacle and into the cover device by the resilience of the resilient receptacle, and a controlling device for controlling the liquid to flow out of the cover device.

The cover device includes a casing provided therein and having a compartment formed in the casing for receiving the liquid forced out of the resilient receptacle. The resilient receptacle includes a peripheral flange for attaching to the cover device, and casing of the cover device is engaged into the peripheral flange of the resilient receptacle.

The cover device includes an inner thread formed therein, and the resilient receptacle includes an outer thread formed on the peripheral flange for detachably attaching the resilient receptacle to the cover device.

The casing includes a bottom wall having an orifice formed therein and communicating with the compartment of the casing for allowing the liquid to flow from the resilient receptacle into the compartment of the casing.

The casing includes a check valve attached thereto for selectively blocking the orifice of the bottom wall of the casing and for controlling the liquid to flow only from the resilient receptacle into the compartment of the casing and to prevent the liquid from flowing backwardly from the compartment of the casing into the resilient receptacle.

The controlling device includes a plug disposed in the casing of the cover device and having an bore formed in the plug and communicating with the compartment of the casing, and a tube slidably engaged through the bore of the plug and having a valve member for blocking the bore of the plug and for selectively opening the bore of the plug when the valve member of the tube is disengaged from the plug.

The tube includes a blind hole formed therein, and at least one opening formed therein for allowing the liquid to flow through the opening of the tube and to flow into the bore of the plug when the valve member of the tube is disengaged from the plug.

A knob may further be provided and includes a conduit formed therein and having a mouth for allowing the liquid to flow out through the mouth, the tube is engaged into the conduit of the knob for allowing the liquid to flow from the tube into the conduit of the knob and to flow out through the mouth of the knob.

A spring member may further be provided and disposed between the knob and the cover device for biasing the knob to move away from the cover device and for biasing the valve member of the tube to block the bore of the plug.

A container may further be provided and attached to the cover device and includes a chamber formed therein for receiving the resilient receptacle. The container includes an air perforation formed therein for allowing air to flow into and out of the chamber of the container.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a liquid dispensing device in accordance with the present invention;

FIG. 2 is an enlarged partial perspective view illustrating a resilient bladder of the liquid dispensing device;

FIG. 3 is a cross sectional view of the liquid dispensing device;

FIG. 4 is a cross sectional view similar to FIG. 3, illustrating the operation of the liquid dispensing device;

FIG. 5 is an exploded view similar to FIG. 1, illustrating the other arrangement of the liquid dispensing device;

FIG. 6 is an enlarged partial perspective view illustrating a resilient bladder of the liquid dispensing device as shown in FIG. 5;

FIG. 7 is an enlarged partial perspective view illustrating a cover member of the liquid dispensing device as shown in FIG. 5; and

FIG. 8 is a cross sectional view of the liquid dispensing device as shown in FIG. 5.

### DETAILED DESCRIPTION OF THE PREFERRED EMBODIMENT

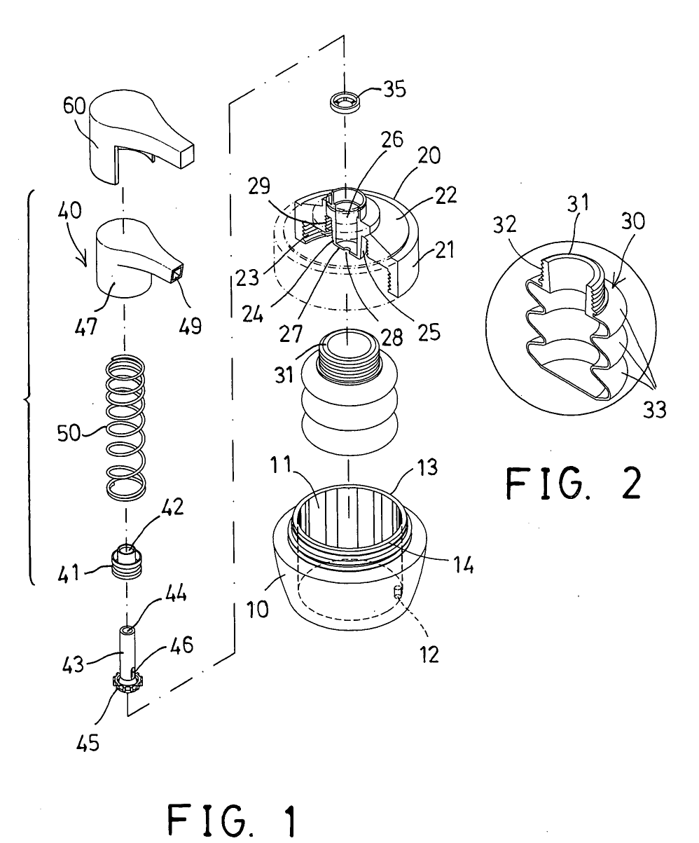

Referring to the drawings, and initially to FIGS. 1-3, a liquid dispensing device 1 in accordance with the present invention comprises an outer housing or container 10 including a chamber 11 formed therein, and including an air perforation 12 formed in the bottom portion thereof for allowing air to flow into and out of the chamber 11 of the container 10, and including an annular or peripheral fence 13 extended upwardly from the upper portion of the container 10, and including an outer thread 14 formed on the outer peripheral portion of the peripheral fence 13. A cover device 20 includes an annular or peripheral wall 21 extended downwardly from a cover plate 22, and an inner thread 23 formed in the inner peripheral portion of the peripheral wall 21 for threading or engaging with the outer thread 14 of the container 10, and for detachably attaching or mounting the cover device 20 to the container 10.

The cover device 20 includes a cylinder or barrel or casing 24 formed or provided in the inner portion of the cover plate 22, and an annular or peripheral space 25 formed between the cover plate 22 and the casing 24, and includes a compartment 26 formed in the casing 24, and the casing 24 includes a bottom wall 27 having an orifice 28 formed therein and communicating with the compartment 26 of the casing 24 and also communicating with the chamber 11 of the container 10 for allowing the air or the liquid or viscous fluid to flow from the chamber 11 of the container 10 into the compartment 26 of the casing 24, and the cover device 20 includes an inner thread 29 formed in the inner portion of the cover plate 22 and facing toward or spaced from the casing 24 for detachably attaching or mounting a resilient bladder or receptacle 30 which is received in the chamber 11 of the container 10.

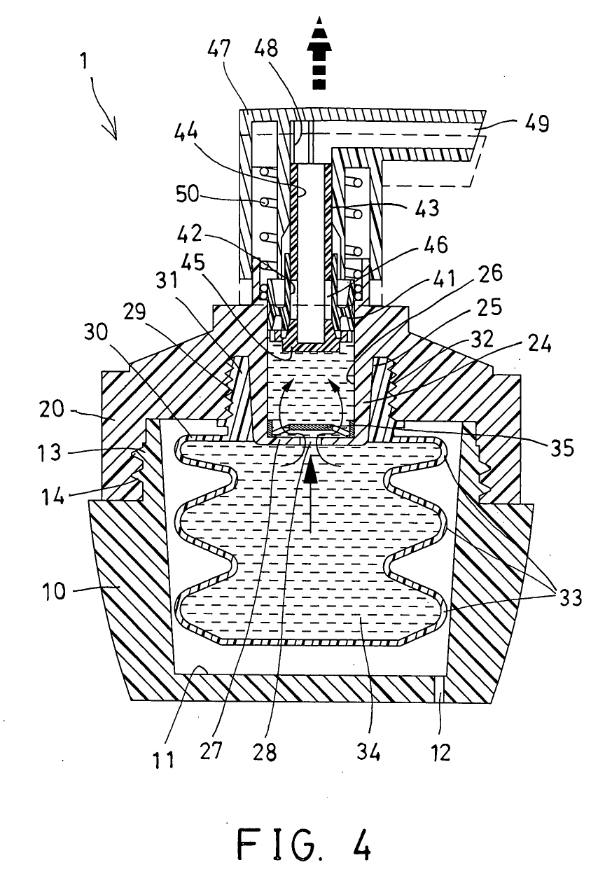

The resilient bladder or receptacle 30 includes an annular or peripheral flange 31 extended upwardly or outwardly therefrom, and includes an outer thread 32 formed on the outer peripheral portion of the peripheral flange 31 for threading or engaging with the outer thread 32 of the resilient receptacle 30, and for detachably attaching or mounting the resilient receptacle 30 to the cover device 20, and includes a bellows-shape having one or more folds 33 for forming or providing a suitable resilience to the resilient receptacle 30, and for allowing the liquid or viscous fluid 34 contained in the resilient receptacle 30 to be forced or squeezed out of the resilient receptacle 30 or to be forced to flow through the orifice 28 of the bottom wall 27 and to flow into the compartment 26 of the casing 24 (FIG. 4). The casing 24 of the cover device 20 is engaged into the peripheral flange 31 of the resilient receptacle 30.

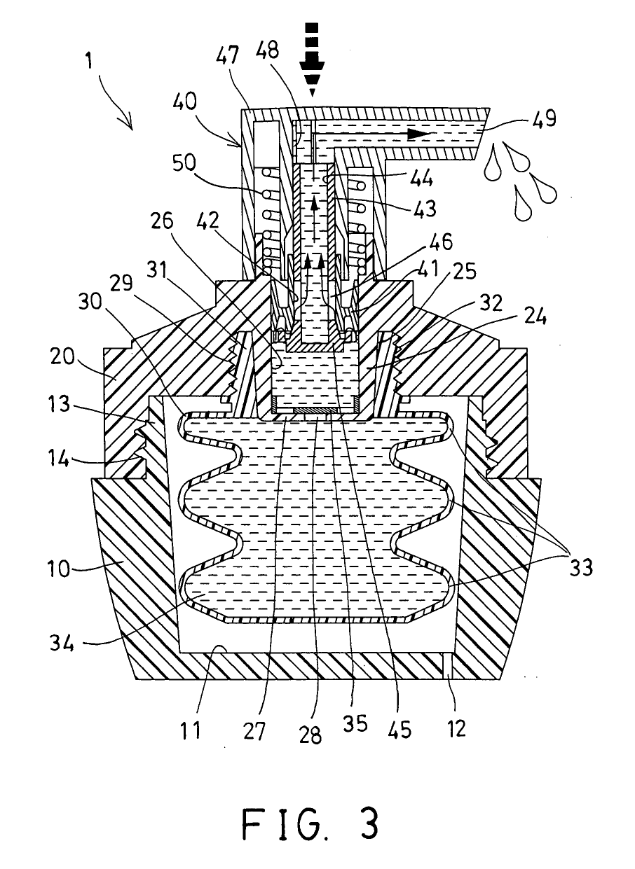

A spring blade or check valve 35 is disposed in the casing 24 of the cover device 20, or attached to the bottom wall 27 of the casing 24 for selectively blocking the orifice 28 of the bottom wall 27 of the casing 24 and for limiting or controlling the liquid or viscous fluid 34 to flow only from the resilient receptacle 30 into the compartment 26 of the casing 24 and to prevent the liquid or viscous fluid 34 from flowing backwardly from the compartment 26 of the casing 24 into the resilient receptacle 30 (FIGS. 3, 4). It is to be noted that the liquid or viscous fluid 34 may be forced or squeezed to flow out of the resilient receptacle 30 and to flow into the compartment 26 of the casing 24 by the resilience of the resilient receptacle 30 without additional pumping devices, such that the liquid dispensing device 1 may be erectly disposed on the supporting tables or surfaces (not shown) or the like without being disposed up side down and without being attached or mounted onto the supporting wall.

A valve or controlling means or device 40 is further provided and attached to the casing 24 or the cover device 20 for actuating or operating or controlling the liquid or viscous fluid 34 to flow out of the casing 24 or the cover device 20. The controlling device 40 includes a plug 41 disposed in the casing 24 of the cover device 20 and having an bore 42 formed therein and communicating with the compartment 26 of the casing 24, and a tube 43 slidably engaged through the bore 42 of the plug 41 and having a blind hole 44 formed therein and having an enlarged head or valve member 45 for selectively blocking the bore 42 of the plug 41 (FIG. 4) and/or for selectively opening the bore 42 of the plug 41 (FIG. 3) when the tube 43 is slid or moved relative to the plug 41 and/or when the valve member 45 of the tube 43 is disengaged or separated from the plug 41.

The tube 43 includes one or more openings 46 formed therein for allowing the liquid or viscous fluid 34 to flow through the openings 46 of the tube 43 and to flow into the bore 42 of the plug 41 (FIG. 4) when the valve member 45 of the tube 43 is disengaged from the plug 41. A knob 47 includes a manifold or conduit 48 formed therein and having an outlet or nozzle or mouth 49 for allowing the liquid or viscous fluid 34 to flow through the mouth 49, the upper portion of the tube 43 is engaged into the conduit 48 of the knob 47 and attached or secured to the knob 47 with such as force-fitted engagements, adhesive materials, or by welding processes, and thus for allowing the liquid or viscous fluid 34 to flow from the blind hole 44 of the tube 43 into the conduit 48 of the knob 47 and then to selectively flow out through the mouth 49 of the knob 47 (FIG. 3).

A spring member 50 may be disposed between the knob 47 and the cover device 20 for biasing or forcing the knob 47 to move away from the cover device 20 and for biasing or forcing the valve member 45 of the tube 43 to block the bore 42 of the plug 41. A cap 60 may further be provided and attached or engaged to the knob 47 for moving or depressing the knob 47 downwardly toward the cover device 20 against the spring member 50, and for selectively moving or disengaging the valve member 45 of the tube 43 from the plug 41 and thus for selectively opening the bore 42 of the plug 41, and thus for allowing the liquid or viscous fluid 34 to flow from the compartment 26 of the casing 24 through the openings 46 of the tube 43 and then to flow into the bore 42 of the plug 41 and the blind hole 44 of the tube 43 and to selectively flow out through the mouth 49 of the knob 47 (FIG. 3).

In operation, as shown in FIG. 4, the spring member 50 may bias or force the valve member 45 of the tube 43 to engage with the plug 41 and to block the bore 42 of the plug 41 and to prevent the liquid or viscous fluid 34 from flowing from the compartment 26 of the casing 24 into the blind hole 44 of the tube 43. As shown in FIG. 3, when the knob 47 is depressed downwardly toward the cover device 20 against the spring member 50, the valve member 45 of the tube 43 may be moved or disengaged from the plug 41 to open the bore 42 of the plug 41, and thus to allow the liquid or viscous fluid 34 to flow from the compartment 26 of the casing 24 through the openings 46 of the tube 43 and then to flow into the bore 42 of the plug 41 and the blind hole 44 of the tube 43 and to flow out through the mouth 49 of the knob 47.

At this moment, or when the knob 47 is moved or depressed downwardly toward the cover device 20, the check valve 35 may be forced to block the orifice 28 of the bottom wall 27 of the casing 24. After dispensing the liquid or viscous fluid, the knob 47 may be released, and the spring member 50 may bias or force the valve member 45 of the tube 43 to engage with the plug 41 and to block the bore 42 of the plug 41 and to prevent the liquid or viscous fluid 34 from flowing from the compartment 26 of the casing 24 into the blind hole 44 of the tube 43. At this moment, the resilient receptacle 30 may force or squeeze the liquid or viscous fluid 34 contained in the resilient receptacle 30 to open the check valve 35 and to flow out of the resilient receptacle 30 or to flow through the orifice 28 of the bottom wall 27 and then to flow into the compartment 26 of the casing 24.

Accordingly, the resilient receptacle 30 may force or squeeze the liquid or viscous fluid 34 to flow out of the resilient receptacle 30 and to flow out through the mouth 49 of the knob 47, such that the liquid dispensing device 1 may be erectly disposed on the supporting tables or surfaces (not shown) or the like without being disposed up side down and without being attached or mounted onto the supporting wall. In addition, after the resilient receptacle 30 is emptied, the other resilient receptacles 30 that are filled with liquid or viscous fluid may be changeably or replaceably attached to the casing 24 or the cover device 20 for allowing the resilient receptacles 30 to be changed or replaced with new ones and for allowing the casing 24 and the cover device 20 to be used again and again.

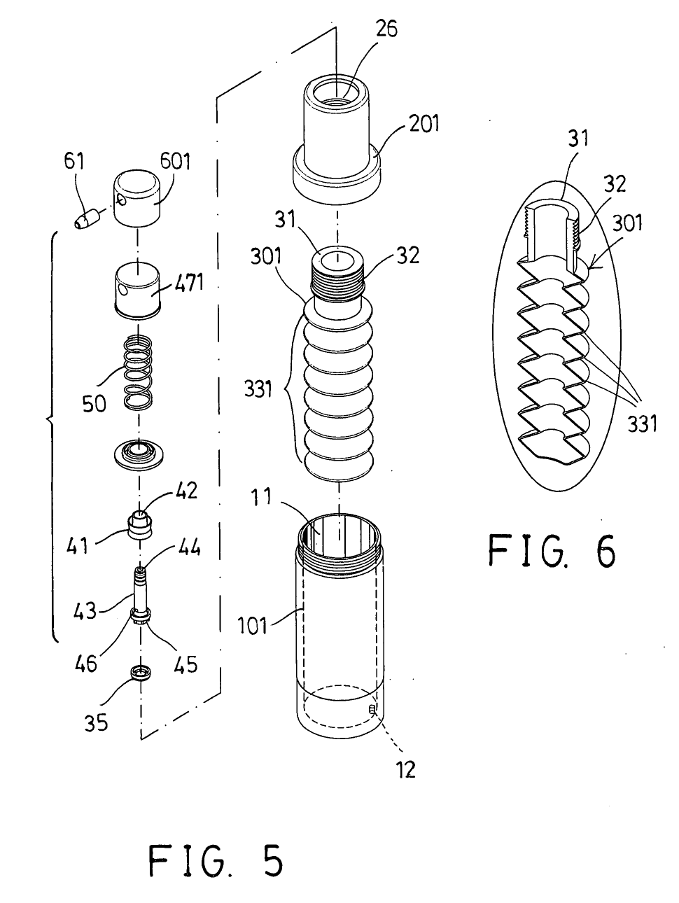

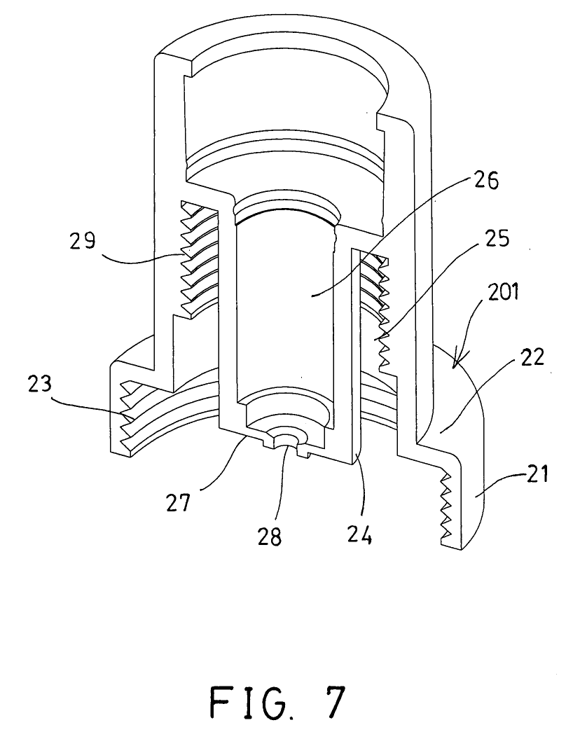

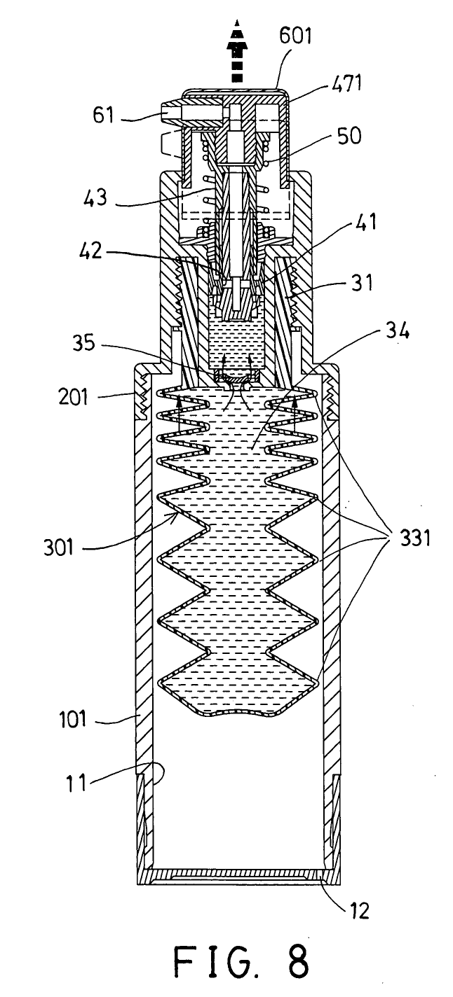

Alternatively, as shown in FIGS. 5-8, the container 101 may include a different size or dimension or volume or shape or contour for receiving the resilient receptacles 301 which may include a different number of the folds 33 for receiving much more liquid or viscous fluid 34 therein, the cap 601 may be engaged with the knob 471 and may include a nozzle 61 attached to the knob 471 and engaged through the cap 601, and the cover 201 may also include a different size or dimension or volume or shape or contour.

Accordingly, the liquid dispensing device in accordance with the present invention includes a resilient bladder or receptacle for containing the liquid or viscous fluid and for forcing the liquid or viscous fluid out of the resilient receptacle and for allowing the liquid dispensing device to be erectly disposed on the table or the like without being disposed up side down and without being attached or mounted onto the supporting wall, and for allowing the receptacle to be changed or replaced with new ones.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A liquid dispensing device comprising:
a cover device,
a resilient receptacle for receiving a liquid and attached to said cover device, and including a bellows-shape for providing a resilience to said resilient receptacle and for forcing the liquid out of said resilient receptacle and into said cover device by the resilience of said resilient receptacle, and
means for controlling the liquid to flow out of said cover device.

2. The liquid dispensing device as claimed in claim 1, wherein said cover device includes a casing provided therein and having a compartment formed in said casing for receiving the liquid forced out of said resilient receptacle.

3. The liquid dispensing device as claimed in claim 2, wherein said resilient receptacle includes a peripheral flange for attaching to said cover device, and casing of said cover device is engaged into said peripheral flange of said resilient receptacle.

4. The liquid dispensing device as claimed in claim 3, wherein said cover device includes an inner thread formed therein, and said resilient receptacle includes an outer thread formed on said peripheral flange for detachably attaching said resilient receptacle to said cover device.

5. The liquid dispensing device as claimed in claim 2, wherein said casing includes a bottom wall having an orifice formed therein and communicating with said compartment of said casing for allowing the liquid to flow from said resilient receptacle into said compartment of said casing.

6. The liquid dispensing device as claimed in claim 5, wherein said casing includes a check valve attached thereto for selectively blocking said orifice of said bottom wall of said casing and for controlling the liquid to flow only from said resilient receptacle into said compartment of said casing and to prevent the liquid from flowing backwardly from said compartment of said casing into said resilient receptacle.

7. The liquid dispensing device as claimed in claim 2, wherein said controlling means includes a plug disposed in said casing of said cover device and having an bore formed in said plug and communicating with said compartment of said casing, and a tube slidably engaged through said bore of said plug and having a valve member for blocking said bore of said plug and for selectively opening said bore of said plug when said valve member of said tube is disengaged from said plug.

8. The liquid dispensing device as claimed in claim 7, wherein said tube includes a blind hole formed therein, and at least one opening formed therein for allowing the liquid to flow through said at least one opening of said tube and to flow into said bore of said plug when said valve member of said tube is disengaged from said plug.

9. The liquid dispensing device as claimed in claim 7, wherein a knob includes a conduit formed therein and having a mouth for allowing the liquid to flow out through said mouth, said tube is engaged into said conduit of said knob for allowing the liquid to flow from said tube into said conduit of said knob and to flow out through said mouth of said knob.

10. The liquid dispensing device as claimed in claim 9, wherein a spring member is disposed between said knob and said cover device for biasing said knob to move away from said cover device and for biasing said valve member of said tube to block said bore of said plug.

11. The liquid dispensing device as claimed in claim 1, wherein a container is attached to said cover device and includes a chamber formed therein for receiving said resilient receptacle.

12. The liquid dispensing device as claimed in claim 11, wherein said container includes an air perforation formed therein for allowing air to flow into and out of said chamber of said container.
